(19) United States
(12) Patent Application Publication
(10) Pub. No.: US 2013/0264137 A1
(43) Pub. Date: Oct. 10, 2013

(54) FRAME-STEERED VEHICLE

(71) Applicants: Lena Larsson, Vastra Frolunda (SE); Jan Öberg, Goteborg (SE)

(72) Inventors: Lena Larsson, Vastra Frolunda (SE); Jan Öberg, Goteborg (SE)

(73) Assignee: Volvo Lastvagnar AB, Goteborg (SE)

(21) Appl. No.: 13/993,350

(22) PCT Filed: Dec. 17, 2010
(86) PCT No.: PCT/SE10/00304

§ 371 Date: Jun. 12, 2013

(51) Int. Cl. B62D 12/00; B60K 6/00

(52) U.S. Cl. CPC B62D 12/00; B60K 6/00
USPC 180/253; 180/252

(57) ABSTRACT

A frame-steered vehicle includes a front frame section including at least one front axle and a rear frame section including at least one rear axle. The front and rear frame sections are arranged along a longitudinal axis and are connected by at least a first pivot joint. The at least first pivot joint has a first pivot axis oriented transversal with respect to the longitudinal direction. The at least one front axle includes driven wheels and at least the at least one rear axle is suspended by a truck-type suspension.

### BACKGROUND AND SUMMARY

The invention relates, according to an aspect thereof, to a frame-steered vehicle comprising a front frame section and a rear frame section connected by a pivot joint.

Frame-steered vehicles, also known as articulated vehicles are well known in the art of heavy off-road construction vehicles. An articulation joint is arranged between a front frame section and a rear frame section of the vehicle so that frame-steered vehicles are very agile and robust when moving off-road. The vehicle is steered by turning the front frame section about the articulation joint. Frame-steered vehicles are normally not designed for driving on normal tarmac roads but on rough ground in construction sites carrying heavy load with a high load per axle which is higher than legal limits for axle load on public tarmac roads. Due to robustness and load carrying requirements in construction areas, such vehicles are already heavy in an empty state and are normally in a fully loaded state too heavy for normal roads. When material loaded on a construction vehicle has to be transported on the road, the material has to be moved from the construction vehicle to a truck which can drive on tarmac roads.

On the other hand, commercial vehicles such as trucks are designed for driving on roads (“on-road”). They cannot be used off-road on very rough roads of construction sites without the risk of severe damage to chassis and other components.

EP 0286878 A2 discloses an all-purpose vehicle with front and rear sections having a rotatable driver cab on the front section while the rear section carries load. The sections are coupled by an articulation joint and can be equipped with a hydropneumatic suspension system. The vehicle can be biaxial or be provided with a tandem axle and be provided with a four-wheel drive.

it is desirable to provide a vehicle which has the agility of a frame-steered vehicle used on construction sites but can drive longer distances on normal roads as well.

A frame-steered vehicle is proposed comprising a front frame section including at least one front axle and a rear frame section including at least one rear axle, the front and rear frame sections being arranged along a longitudinal axis and being connected by at least a first pivot joint, wherein the at least first pivot joint has a first pivot axis. The at least one front axle comprises driven wheels and that the first pivot axis of the first pivot joint is oriented transversal with respect to the longitudinal direction and that at least the at least one rear axle is suspended by a truck-type suspension.

Advantageously, a short and compact front frame section can be provided with a high agility and the possibility to reduce axle and wheel load. Preferably, the driven wheels may be individually driven wheels or parallel driven wheels. There is no propeller shaft extending from a central drive unit (such as a combustion engine) to the driven wheels on the front axle for propulsion of the driven wheels. Particularly, each driven wheel may have its own individual drive unit, such as an individual wheel motor. Particularly, a front wheel speed or torque may be established individually at least between the front wheels at the same front axle, and/or also compared to wheels arranged on axles in the rear frame section. Because there is no propeller shaft the vehicle has a reduced weight. Further, a drop box (also called transfer box) is not necessary in the front frame section, saving space and weight. A frame-steered vehicle can have wider tires on the front axle so that more loads can be carried by the vehicle.

Advantageously, the vehicle has an ordinary truck-type suspension, where the wheels on one side of the vehicle can move at least vertically independent from wheels on the other side of the vehicle. If two or more of the wheels are attached to a physical axle component, the axle component can move vertically relative to the frame. Having a truck-type suspension allows the vehicle to run with improved comfort and higher speed on normal roads. As a result, a vehicle, particularly a construction vehicle, can be provided which is capable of safely and comfortably moving off-road as well of on-road while carrying a reasonable weight of payload.

Expediently, the rear frame section may have at least two axles. The advantage of at least two rear axles is a higher load carrying capacity of the vehicle and a reduced risk of damage to the ground by the wheels, thereby maintaining a higher friction and load carrying capacity of the ground.

Particularly, the front frame section may comprise only one front axle or one front axle aggregate. The front frame section is used with the rear frame section in combination only.

According to an embodiment of an aspect of the invention, at least one of an electric motor and a hydraulic motor may be provided for driving the driven wheels. Particularly, the drive units driving the wheels can be integrated in the wheels. Advantageously, such drive units can be mounted in a compact way and act directly on the driven wheels. Because there is no propeller shaft and transfer box for driving the driven front wheels, it is possible to mount the second joint close to the front axle. It is of advantage for vehicle stability that the second joint (longitudinal joint) is close to the front axle. Instead of a large bulky propeller shaft and transfer box, a hydraulic pump or a generator or the like for supplying energy to the wheel drive units can be mounted.

Conventional frame-steered trucks designed for construction sites have a much lower speed when reversing compared to forward drive.

Advantageously, torque transmitted to the wheels at the front and rear part of the vehicle may be individually controllable and/or individually distributable to the individual wheels or one or more axles depending on operating parameters of the vehicle. Particularly, the torque can be individually controlled as a function of available ground friction and/or slip control. Alternatively or additionally, the torque to the wheels can be individually controlled to obtain an increased or decreased steering angle. Alternatively or additionally, the torque to the wheels can be individually controlled to stabilize the vehicle and reduce skidding. Alternatively or additionally, the torque to the wheels can be individually controlled to obtain a more efficient use of the articulated joint for agility by wag the steering left and right (so-called “duck walk”).

Advantageously, a distance between the front wheel axle and the second pivot joint is as small as possible, preferably comparable to, more preferably not larger as the wheel hub distance (also called “traction width”). The shorter the distance, the more stable is the vehicle. An undesired instability when turning the front frame section which may lead to fold down of the front and rear frame section can be avoided.

According to a further favourable embodiment of an aspect of the invention, a central drive unit, e.g. an internal combustion engine, may be arranged substantially above the at least one front axle. The driver position may also be arranged substantially above the at least one front axle. The arrangement corresponds to the arrangement in a conventional truck. It is of advantage that components used for normal trucks can be used for the frame steered vehicle. Particularly, a normal cab of a truck can be used as cab for the frame-steered vehicle, thus reducing manufacturing costs of the vehicle as same parts for trucks and construction vehicles can be used.

According to a further favourable embodiment of an aspect of the invention, the front and/or the rear frame section may be composed of truck beam components. It is of advantage that components used for normal trucks can be used for the frame-steered vehicle. The beams can have a C-shape cross section. Of course, other cross sections are possible, such as a T-shape, a double-T-shape, Z-shape, a square, as is used for conventional truck frames.

According to a further favourable embodiment of an aspect of the invention, the at least one rear axle may be driven by a propeller shaft coupled to a drive unit, e.g. an internal combustion engine, providing drive power for the at least one rear axle of the vehicle. Expediently, the drive unit is arranged on the front frame section.

According to a further favourable embodiment of an aspect of the invention, the rear frame section may comprise a bogie axle aggregate. Advantageously, components used for normal trucks can be used for the frame steered vehicle, thus reducing manufacturing costs of the vehicle.

According to a further favourable embodiment of an aspect of the invention, the rear frame section may comprise at least one of a leaf spring suspension and an air spring suspension, gas suspension, hydraulic suspension, or combination of two or more of these. Advantageously, components used for normal trucks can be used for the frame steered vehicle, thus reducing manufacturing costs of the vehicle.

According to a further favourable embodiment of an aspect of the invention, a second joint may be provided having a pivot axis in the longitudinal direction. Twisting of the front frame section and/or the rear frame section about the longitudinal axis of the vehicle improves the agility and maneuverability of the vehicle on rough surfaces.

Particularly, the second pivot joint may have a locked state, thus improving the drivability and stability of the vehicle when driving in high speed on even surfaces.

According to a further favourable embodiment of an aspect of the invention, a bearing of the second joint may be arranged around a gearbox, thus providing a compact and space-saving arrangement of the second joint. It is of advantage when the second pivot joint is closer to the front axle than the first pivot joint, as the vehicle can be steered with a comparably large angle and at the same time prevent fold down of the front and rear frame section.

According to a further favourable embodiment of an aspect of the invention, a steerable axle may be arranged at the rear frame section. The drivability and stability of the vehicle can be improved compared to an “overloaded” rear section with two axles.

According to a further favourable embodiment of an aspect of the invention, the front axle may have individually steerable wheels. The steering can be performed by action of the individual drive units of the driven wheels on the front axle.

### BRIEF DESCRIPTION OF THE DRAWINGS

The present invention may best be understood from the following detailed description of the embodiments, but not restricted to the embodiments, wherein is shown schematically:

FIG. 1 in a side view an example embodiment of a frame steered vehicle according to an aspect of the invention;

FIG. 2 in a top view the vehicle of FIG. 1; and

FIG. 3 a steering geometry of an example embodiment of a frame steered vehicle in a top view according to an aspect of the invention.

### DETAILED DESCRIPTION

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

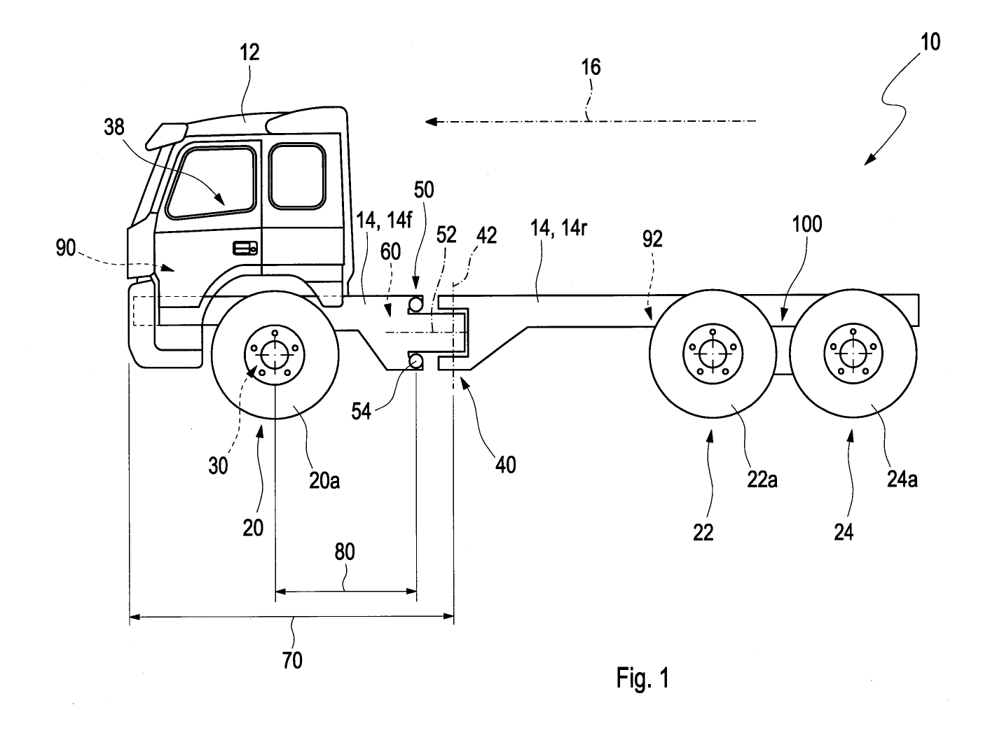

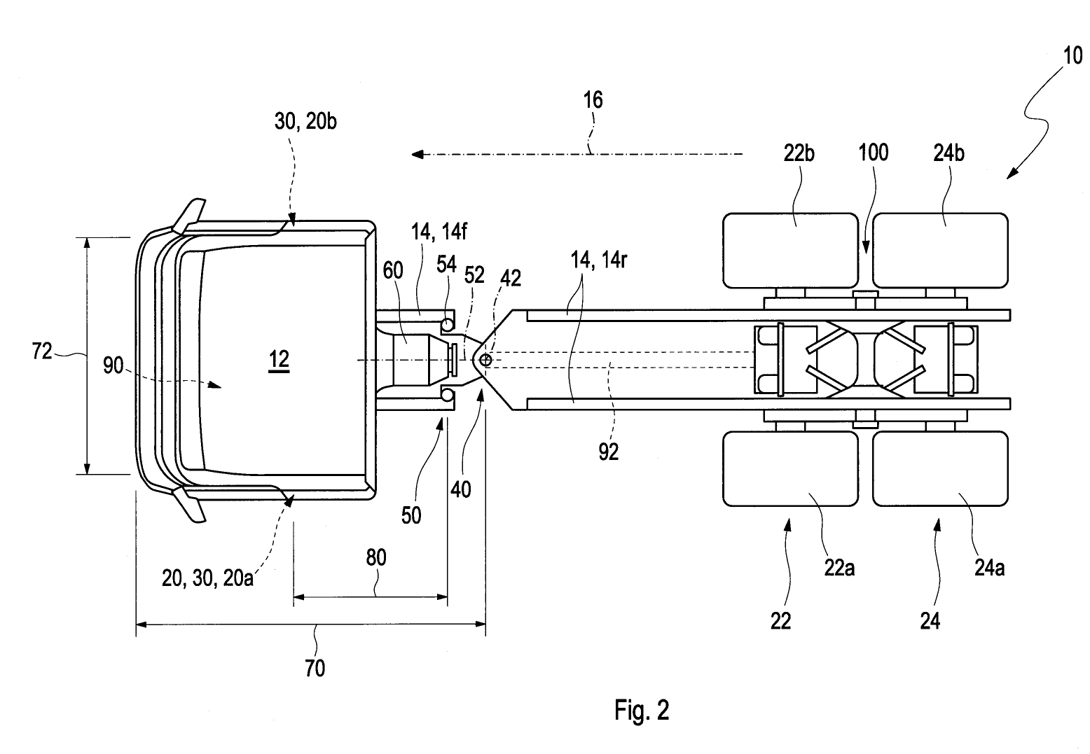

An example embodiment of a frame-steered vehicle 10 is depicted in FIG. 1 in a side view and in a plan view in FIG. 2. The vehicle 10 comprises a frame 14 including a front frame section 14f and a rear frame section 14r. The front frame section 14f includes a front axle 20 and the rear frame section 14r includes two rear axles 22, 24. The front frame section 14f has a longitudinal extension 70.

The front and rear frame sections 14f, 14r are arranged along a longitudinal axis 16 and are connected by a first pivot joint 40 having a first pivot axis 42 in a direction transverse to the longitudinal direction 16, i.e. perpendicular to the ground. The first pivot joint 42 constitutes the articulation joint which allows for turning the front frame section 14f for steering the vehicle 10.

The front axle 20 comprises a pair of driven wheels 20a, 20b. The driven wheels 20a, 20b of the front axle 20 are individually driven so that each driven wheel 20a, 20b has its own drive unit 30, e.g. a wheel motor, the position of which is indicated by an arrow. Such individual drive units 30 are associated with the wheels 20a, 20b so that the from wheel speed or torque can be established individually at least to each other and/or also compared to rear wheels 22a, 22b, 24a, 24b of the rear axles 22, 24. The drive unit 30 can be, for instance, an electric motor, a hydraulic motor and the like. The driven wheels 20a, 20b are not connected to a propeller shaft coupled to a central drive unit such as a combustion engine 90.

The front wheel speeds can be individually or together controlled and compensate for the longer or shorter distance of travel in turns compared to the rear wheels 22a, 22b, 24a, 24b.

A second joint 50 is provided having a pivot axis 52 in the longitudinal direction 16, thus allowing a twist of the vehicle 10 about the longitudinal direction 16 as desired when the vehicle 10 is moving on rough surfaces. The second pivot joint 50 constitutes an oscillation joint of the vehicle 10. A bearing 54 of the second joint 50 is arranged around a gearbox 60. The second pivot joint 50 is arranged between the front axle 20 and the first pivot joint 40. Expediently, the front and rear frame section 14f, 14r can perform articulated and oscillation movements compared to each other.

A longitudinal extension 80 between the centre of the front axle 20 and the centre of the second pivot joint 50 (here indicated by bearing 54) of the from frame section 14f along the longitudinal direction 16 is favourably short, for instance has an extension comparable to a wheel hub distance 72 of the front axle 20. Other than known for conventional frame-steered vehicles, a cab 12 as known from conventional trucks can be used as driver cab. The vehicle 10 can comprise more conventional truck components. For instance, the front and/or the rear frame section 14f, 14r can be composed of C-shaped beams well known from trucks. Of course, other cross sections are possible. By way of example, the rear frame section 14r may comprise a bogie axle aggregate 100 including the rear axles 22, 24. Further, the rear frame section 14r may comprise a leaf spring suspension or an air spring suspension.

At least one of the rear axles 22, 24, or both, is driven by a propeller shaft coupled to a central drive unit 90, such as an internal combustion engine 90, arranged at the front frame section 14f.

If the front axle 20 can be in the same position with respect to the frame 14 as in a standard road truck, the vehicle approach angle and the front axle load will be reasonable. The vehicle approach angle is to be understood as the angle between the front wheels (in case of more front axles the foremost of the front wheels) and the lowest point of the vehicle which would be hit by a slope of an inclined ground. The vehicle approach angle is a measure for the inclination of a slope which the vehicle can cope with. Thus, the smaller the front overhang of a vehicle is, i.e. the portion of the vehicle extending beyond the front wheels in longitudinal direction, the steeper the slopes can be which the vehicle can drive on.

For a stable drive, particularly on even ground such as tarmac roads, the second pivot joint 50 has a locked state.

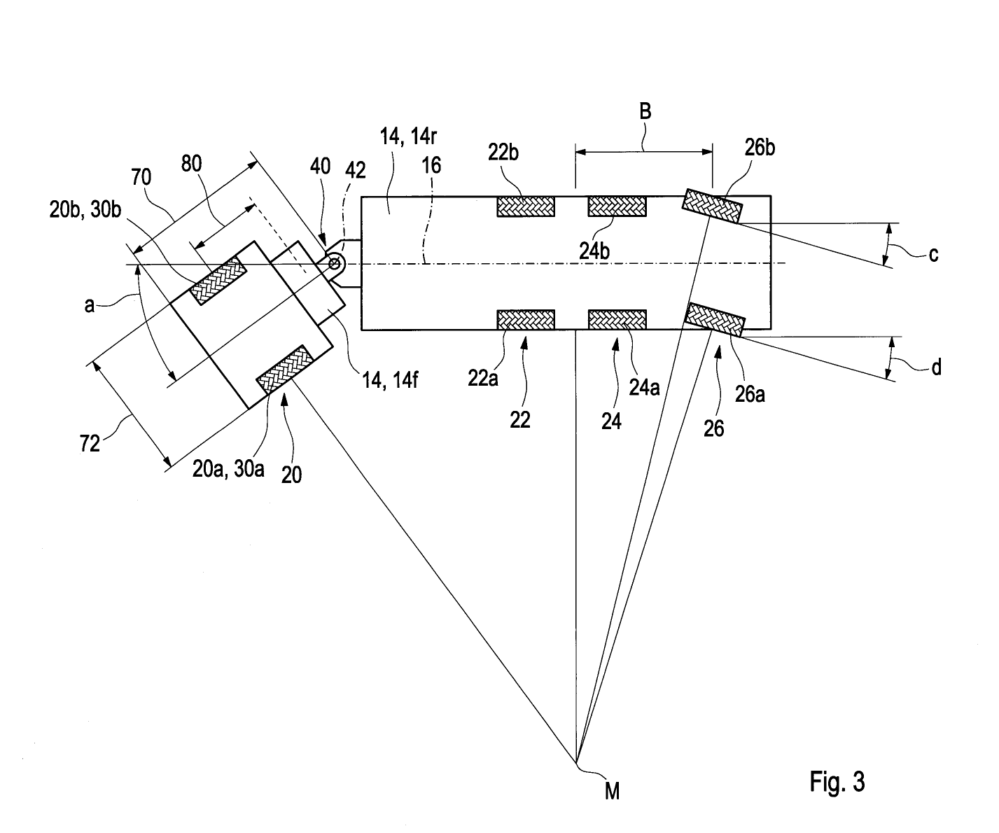

FIG. 3 shows in a schematic plan view of a vehicle 10 similar to the vehicle 10 shown in FIGS. 1 and 2, indicating the steering geometry of the vehicle 10. For the general description it is referred to the description of FIGS. 1 and 2 to avoid unnecessary repetitions.

The vehicle 10 has a front axle 20 in the front frame section 14f with driven wheels 20a, 20b, where the wheel 20a is driven by drive unit 30a and the wheel 20b is driven by drive unit 30b. The rear frame section 14r has three rear axles 22 (with wheels 22a, 22b), 24 (with wheels 24a, 24b), and 26 (with wheels 26a, 26b), where the rearmost axle 26 is steerable.

When cornering, the front frame section 14f is turned about the first pivot joint 40 by an angle a, and the wheels 26a, 26b of the rearmost axle 26 are turned by an angle c for wheel 26b and an angle d for wheel 26a. The front section, bogie axle and the steerable wheels' longitudinal axles can all be tangential to the common turning radius centre point M.

The frame-steered vehicle 10 according to an aspect of the invention is designed for off-road and on-road driving. For on-road driving the vehicle 10 can be used like a conventional truck, for off-road driving the vehicle 10 can be used like a conventional off-road articulated vehicle like a dumper The frame-steered vehicle 10 combines the features of an on-road truck and an articulated hauler. Compared to an ordinary off-road articulated vehicle the vehicle 10 provides high driving speed. Transportation of payload can be done both off-road and on-road with the same vehicle 10.

1. A frame-steered vehicle (10) comprising a front frame section (14f) including at least one front axle (20) and a rear frame section (14r) including at least one rear axle (22, 24, 26), the front and rear frame sections (14f, 14r) being arranged along a longitudinal axis (16) and being connected by at least a first pivot joint (40), wherein the at least first pivot joint (40) has a first pivot axis (42) oriented transversal with respect to the longitudinal direction (16), characterized in that the at least one front axle (20) comprises driven wheels (20a,20b) and that at least the at least one rear axle (22, 24, 26) is suspended by a truck-type suspension.

2. The frame-steered vehicle according to claim 1, characterized in that at least one of an electric motor (30) and a hydraulic motor is provided for driving the driven wheels (20a, 20b).

3. The frame-steered vehicle according to claim 1 or 2, characterized in that torque transmitted to the wheels (20a, 20b, 22a, 22b, 24a, 24b, 26a, 26b) at the front and rear part of the vehicle is individually controllable and/or is distributable to the individual wheels (20a, 20b, 22a, 22b, 24a, 24b, 26a, 26b) or one or more axles (20, 22, 24, 26) depending on operating parameters of the vehicle.

4. The frame-steered vehicle according to any one of the preceding claims, characterized in that a central drive unit (90) is arranged substantially above the at least one front axle (20).

5. The frame-steered vehicle according to any one of the preceding claims, characterized in that the at least one rear axle (22, 24, 26) is driven by a propeller shaft coupled to a central drive unit (90).

6. The frame-steered vehicle according to any one of the preceding claims, characterized in that the front and/or the rear frame section (14f, 14r) is composed of truck-beam components.

7. The frame-steered vehicle according to any one of the preceding claims, characterized in that the rear frame section (14r) comprises a bogie axle (100).

8. The frame-steered vehicle according to any one of the preceding claims, characterized in that the rear frame section (14r) comprises at least one of a leaf spring suspension and an air spring suspension, gas suspension, hydraulic suspension, or any combination thereof.

9. The frame-steered vehicle according to any one of the preceding claims, characterized in that a second joint (50) is provided having a pivot axis (52) in the longitudinal direction (16).

10. The frame-steered vehicle according to claim 9, characterized in that a longitudinal extension (80) between a centre of the front axle (20) and a centre of the second pivot joint (50) is comparable to a wheel hub distance (72) of the at least one front axle (20).

11. The frame-steered vehicle according to claim 9 or 10, characterized in that the second pivot joint (50) has a locked state.

12. The frame-steered vehicle according to any one of the preceding claims, characterized in that the front axle (20) has individually steerable wheels (20a, 20b).

13. The frame-steered vehicle according to any one of the preceding claims, characterized in that the second pivot joint (50) is arranged between the front axle (20) and the first pivot joint (40).

14. The frame-steered vehicle according to any one of the preceding claims, characterized in that a bearing (54) of the second joint (50) is arranged around a gearbox (60).

15. The frame-steered vehicle according to any one of the preceding claims, characterized in that a steerable axle (26) is arranged at the rear frame section (14r).

16. A frame-steered vehicle comprising a front frame section including at least one front axle and a rear frame section including at least one rear axle, the front and rear frame sections being arranged along a longitudinal axis and being connected by at least a first pivot joint, wherein the at least first pivot joint has a first pivot axis oriented transversal with respect to the longitudinal direction, characterized in that the at least one front axle comprises driven wheels and that at least the at least one rear axle is suspended by a truck-type suspension.

17. The frame-steered vehicle according to claim 16, characterized in that at least one of an electric motor and a hydraulic motor is provided for driving the driven wheels.

18. The frame-steered vehicle according to claim 16, characterized in that torque transmitted to the wheels at the front and rear part of the vehicle is individually controllable and/or is distributable to the individual wheels or one or more axles depending on operating parameters of the vehicle.

19. The frame-steered vehicle according to claim 16, characterized in that a central drive unit is arranged substantially above the at least one front axle.

20. The frame-steered vehicle according to claim 16, characterized in that the at least one rear axle is driven by a propeller shaft coupled to a central drive unit.

21. The frame-steered vehicle according to claim 16, characterized in that the front and/or the rear frame section is composed of truck beam components.

22. The frame-steered vehicle according to claim 16, characterized in that the rear frame section comprises a bogie axle.

23. The frame-steered vehicle according to claim 16, characterized in that the rear frame section comprises at least one of a leaf spring suspension and an air spring suspension, gas suspension, hydraulic suspension, or any combination thereof.

24. The frame-steered vehicle according to claim 16, characterized in that a second joint is provided having a pivot axis in the longitudinal direction.

25. The frame-steered vehicle according to claim 24, characterized in that a longitudinal extension between a centre of the front axle and a centre of the second pivot joint is comparable to a wheel hub distance of the at least one front axle.

26. The frame-steered vehicle according to claim 24, characterized in that the second pivot joint has a locked state.

27. The frame-steered vehicle according to claim 16, characterized in that the front axle has individually steerable wheels.

28. The frame-steered vehicle according to claim 16, characterized in that the second pivot joint is arranged between the front axle and the first pivot joint.

29. The frame-steered vehicle according to claim 16, characterized in that a bearing of the second joint is arranged around a gearbox.

30. The frame-steered vehicle according to claim 16, characterized in that a steerable axle is arranged at the rear frame section.
